(19) United States
(12) Patent Application Publication
(10) Pub. No.: US 2025/0030679 A1
(43) Pub. Date: Jan. 23, 2025

(54) TEMPORARY BREAK GLASS ACCOUNT-BASED DATA CENTER OPERATIONS

(71) Applicant: VMWARE, INC., Palo Alto, CA (US)

(72) Inventors: AMARNATH REDDY, Bangalore (IN); Raj Shekar Chelur, Cary, NC (US); Naren Lal, Bangalore (IN); Srinivasan Angamuthu, Bangalore (IN)

(21) Appl. No.: 18/377,773

(22) Filed: Oct. 7, 2023

(30) Foreign Application Priority Data
Jul. 21, 2023 (IN) 202341049296

(51) Int. Cl. H04L 9/40

(52) U.S. Cl. CPC H04L 63/083; H04L 63/20

(57) ABSTRACT

An example method may include receiving a request to create a temporary break glass account from a user associated with a user account. The request may include a time period for accessing a data center resource. In response to receiving the request, the temporary break glass account may be created. Further, credentials associated with the temporary break glass account may be notified to the user. Furthermore, an operation may be enabled on the data center resource via the temporary break glass account using the credentials. Further, the temporary break glass account may be deleted in response to an expiration of a timer. The timer may be configured based on the time period.

### RELATED APPLICATIONS

Benefit is claimed under 35 U.S.C. 119 (a)-(d) to Foreign application Serial No. 202341049296 filed in India entitled “TEMPORARY BREAK GLASS ACCOUNT-BASED DATA CENTER OPERATIONS”, on Jul. 21, 2023, by VMware, Inc., which is herein incorporated in its entirety by reference for all purposes.

### TECHNICAL FIELD

The present disclosure relates to computing environments, and more particularly to methods, techniques, and systems for creating a temporary break glass account for enabling data center operations.

### BACKGROUND

A data center is a facility that houses a wide range of data center resources such as servers, storage devices, communication equipment, and the like, organized into clusters. For example, an information technology (IT) service provider may maintain a data center. An enterprise may purchase data storage and/or data processing services from the provider in order to run applications that manage the enterprises' core business and operational data.

The security of such data center resources and associated data is of high importance in many contexts. As an example, organizations often utilize networks of computing devices to provide a robust set of services to their users. In many situations, access to these services and other network resources requires that a user provide some type of credential, often a password, to authenticate the user's identity and obtain authorization for that access through a user account or other such information. Because passwords can be stolen, guessed, or otherwise obtained by unauthorized parties, organizations often require users to periodically change or “rotate” their passwords over time.

### BRIEF DESCRIPTION OF THE DRAWINGS

FIG. 1 is a block diagram of an example computing environment, depicting a management node to create a temporary break glass account for data center operations;

FIG. 2 is a block diagram of another example computing environment, depicting a data center manager to generate a temporary break glass account for data center operations;

FIG. 3 is a sequence diagram illustrating an example sequence of events to create a temporary break glass account corresponding to a user account;

FIG. 4 is a flow diagram illustrating an example method for creating a temporary break glass account to perform an operation on a data center resource.

FIG. 5A is an example graphical user interface of a user account, depicting user-selectable options to be included in a request to create a temporary break glass account;

FIG. 5B is an example graphical user interface of an administrator account, depicting a notification seeking the administrator's approval to create the temporary break glass account;

FIG. 5C is an example graphical user interface of the user account, depicting details of the created temporary break glass account; and

FIG. 6 is a block diagram of an example computing device including non-transitory computer-readable storage medium storing instructions to create a temporary break glass account associated with a user account to perform an operation on a data center resource.

The drawings described herein are for illustrative purposes and are not intended to limit the scope of the present subject matter in any way.

### DETAILED DESCRIPTION

Examples described herein may provide an enhanced computer-based and/or network-based method, technique, and system to create a temporary break glass account corresponding to a user account to perform operations on a data center resource. The paragraphs [0014] to [0019] present an overview of the computing environment, existing methods to manage credentials for performing data center operations in the computing environment, and drawbacks associated with the existing methods.

Computing environment may be a physical computing environment (e.g., an on-premises enterprise computing environment or a physical data center) and/or virtual computing environment (e.g., a cloud computing environment, a virtualized environment, and the like). The virtual computing environment may be a pool or collection of cloud infrastructure resources (also referred to as data center resources) designed for enterprise needs. The data center resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in a virtual space being hosted by one or more physical data centers. Example virtual computing environment may include different compute nodes (e.g., physical computers, virtual machines, and/or containers). Further, the computing environment may include multiple application hosts (i.e., physical computers) executing different workloads such as virtual machines, containers, and the like running therein. Each compute node may execute different types of applications and/or operating systems.

The data center can be an on-premises data center, a cloud data center, or a hybrid data center. For example, the data center can be a software-defined data center (SDDC) having a hyper-converged infrastructure solution. The term “hyper-converged infrastructure” may refer to a type of virtual computing platform that converges compute, networking, virtualization, and storage into a single software-defined architecture. The hyperconverged infrastructure may include virtualized computing (e.g., a hypervisor), a virtual storage area network (vSAN) (e.g., software-defined storage), and virtualized networking (e.g., software-defined networking). For example, Vmware® cloud foundation (VCF) is a hybrid cloud platform for managing virtual machines and orchestrating containers, built on a full stack hyperconverged infrastructure technology.

Such hyperconverged infrastructures introduces the use of workload domains in hybrid clouds. Workload domains are physically isolated containers that hold (e.g., execute) a group of applications with a substantially similar performance requirement, availability requirement, and/or security requirement executing on one or more compute nodes (e.g., servers). The workload domains may include different combinations of servers (i.e., physical hosts) and network equipment which can be set up with varying levels of hardware redundancy and varying quality of components. A workload domain may represent a logical unit that groups physical hosts (e.g., enterprise-class, type-1 hypervisor (ESXi) servers) managed by a server instance (e.g., vCenter server) with specific characteristics according to software defined data center (SDDC) polices. Thus, the workload domain may include multiple clusters of physical hosts.

The cluster may be a collection of resources (e.g., physical hosts) that collectively provide scalable services to end users and to their applications while maintaining a consistent, uniform, and single system view of the cluster services. Each node may be a single entity machine or server having compute, storage, and/or network capacity. An example cluster may be a stretched cluster, a multi-availability zone (AZ) cluster, a metro cluster, or a high availability (HA) cluster that crosses multiple areas within a local area network (LAN), a wide area network (WAN), or the like. By design, the cluster may provide a single point of control for cluster administrators and at the same time, the cluster may facilitate addition, removal, or replacement of individual resources without significantly affecting the services provided by the hyperconverged infrastructure.

Such cloud platforms may offer centralized control for deployed resources (e.g., VMware® vCenter™ Server (i.e., a centralized management utility to manage virtual machines), a virtual storage area network (vSAN) (a storage virtualization application to provide software defined storage solution), NSX-T (e.g., a unified networking platform to build cloud-native application environments), ESXI servers, and the like in the hyperconverged infrastructure.

Further, security of such data center resources and associated data is of high importance. In this regard, a user or client may have to provide credentials, often a password, to authenticate the user's identity and obtain authorization for performing operations on the data center resources through a user account. In some examples, privileged account credentials to manage a data center stack may be stored in password vaults. Further, organizational security policies may require rotation of the passwords within a certain time period (e.g., 8 hours) after the passwords are obtained from the vault. In this example, the rotation of passwords may incur operational overhead and any failure in password rotation results in non-compliance. Further, the privileged accounts may have to be used only for real break glass scenario. Instead, administrator accounts may get used often for troubleshooting, and sometimes in automations due to lack of required application programming interfaces (APIs). This may create continuous operational overhead to ensure compliance to password rotation policies. In addition, multiple products use a set of administrator accounts. In this scenario, the root credentials may have to be shared in order for administrator activities to be carried out. Further, the rotation of passwords in this example may require updates on the dependent accounts and may be prone to failure. This may also result in management layer downtime in the computing environment.

Examples described herein may provide a management node including a data center manager to create a temporary break glass account for data center operations. The data center manager may receive a request to create a temporary break glass account from a user associated with a user account. The request may include a time period for accessing a data center resource. In response to receiving the request, the data center manager may create the temporary break glass account. Further, the data center manager may notify credentials associated with the temporary break glass account to the user and enable an operation on the data center resource via the temporary break glass account using the credentials. Furthermore, the management node may include a scheduler to initiate a timer upon creating the temporary break glass account. The timer may be configured based on the time period. In response to an expiration of the timer, the scheduler may delete the temporary break glass account.

Examples described herein may provide an approach to create a one-time temporary break glass account with the required privileged access to the data center resource with a short period of time, which may significantly reduce the operational cost. Thus, examples described herein may significantly remove the operational overhead of having to access the password from a vault and ensuring its rotation after use. Further, examples described herein may provide significantly enhanced audit capabilities as each temporary break glass account is tied to an individual administrator/user who requested it, instead of sharing the default break glass accounts like root or administrator.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

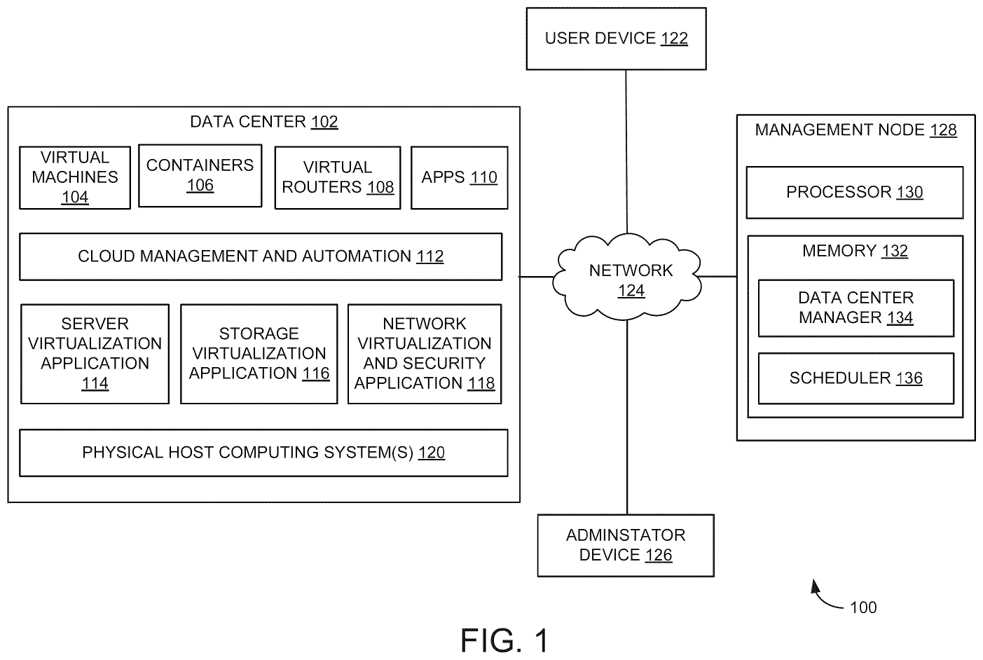

Referring now to the figures, FIG. 1 is a block diagram of an example computing environment 100, depicting a management node 128 to create a temporary break glass account for data center operations. Computing environment 100 may be based on the deployment of physical resources across a network, virtualizing the physical resources into virtual resources, and provisioning the virtual resources in a data center 102 for use across cloud computing services and applications. Data center 102 may refer to a centralized physical facility where servers, network, storage, and other information technology equipment that support business operations exist. Further, components or resources in data center 102 include or facilitate business-critical applications, services, data, and the like.

For example, data center 102 may be a software-defined data center (SDDC) with hyperconverged infrastructure (HCl). In SDDC with hyper-converged infrastructure, networking, storage, processing, and security may be virtualized and delivered as a service. The hyper-converged infrastructure may combine a virtualization platform such as a hypervisor, virtualized software-defined storage, and virtualized networking in deployment of data center 102. For example, data center 102 may include different resources such as a server virtualization application 114 (e.g., vSphere of VMware®), a storage virtualization application 116 (e.g., vSAN of VMware®), a network virtualization and security application 118 (e.g., NSX of VMware®), physical host computing systems 120 (e.g., ESXi servers), or any combination thereof.

Further, data center 102 may include a cloud management and automation platform 112 to deploy different resources and manage different workloads such as virtual machines 104, containers 106, virtual routers 108, applications 110, and the like. Virtual machines 104, in some examples, may operate with their own guest operating systems on a physical computing device using resources of the physical computing device virtualized by virtualization software (e.g., a hypervisor, a virtual machine monitor, and the like). Containers are data computer nodes that run on top of the host operating systems without the need for a hypervisor or separate operating system. In some examples, data center 102 may include one or more workload domains, each workload domain representing a logical unit that groups physical computing devices managed by management node 102 (e.g., VMware® vCenter™ Server) with specific characteristics according to SDDC polices.

An example platform to deploy and manage data center 102 may include VMware Cloud Foundation™ (VCF), which is commercially available from VMware. VCF may be a hybrid cloud platform that provides a full stack hyperconverged infrastructure that is made for modernizing data centers and deploying modern container-based applications. VCF integrates different resources like vSphere (compute resource), vSAN (storage resource). NSX (networking resource), and some parts of the vRealize Suite in a hyper-converged infrastructure solution with infrastructure automation and software lifecycle management. The idea of VCF follows a standardized, automated, and validated approach that simplifies the management of the needed software-defined infrastructure resources. So. VCF is fully integrated software composed of vSphere, NSX, vSAN, and SDDC manager based on the concepts of HCl, which accelerates the delivery of virtual infrastructure (VI) or virtual desktop infrastructure (VDI).

Data center operations refer to the workflow and processes that are performed within data center 102 to keep data center 102 running. The data center operations include computing and non-computing processes that are specific to a data center facility or data center environment. The data center operations include automated and manual processes essential to keep the data center operational. For example, the data center operations include installing and maintaining resources, deleting the resources, ensuring data center security and monitoring systems that take care of power and cooling, and the like.

As shown in FIG. 1, data center 102 may be communicatively connected to management node 128 via network 124. For example, network 124 can be a managed Internet protocol (IP) network administered by a service provider. For example, network 124 may be implemented using wireless protocols and technologies, such as Wi-Fi, WiMAX, and the like. In other examples, network 124 can also be a packet-switched network such as a local area network, wide area network, metropolitan area network, Internet network, or other similar type of network environment. In yet other examples, network 124 may be a fixed wireless network, a wireless local area network (LAN), a wireless wide area network (WAN), a personal area network (PAN), a virtual private network (VPN), intranet or other suitable network system and includes equipment for receiving and transmitting signals.

Management node 128 may include a processor 130. Processor 130 may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 130 may, for example, include single or multiple cores on a chip, multiple cores across multiple chips, multiple cores across multiple devices, or suitable combinations thereof. Processor 130 may be functional to fetch, decode, and execute instructions as described herein. Further, management node 128 includes memory 132 coupled to processor 130. Memory 132 includes a data center manager 134 and a scheduler 136. Furthermore, computing environment 100 may include multiple user devices (e.g., a user device 122) for accessing different data center resources and an administrator device 126 for managing the data center resources.

During operation, data center manager 134 may receive a request to create a temporary break glass account from a user associated with a user account (e.g., via user device 122). The request may include a time period for accessing a data center resource. The time period may indicate the amount of permitted time (e.g., 2 hours) or permitted period (e.g., 9 AM to 12 PM) to perform an operation on the data center resource.

For example, data center manager 134 may receive the request to create the temporary break glass account via a graphical user interface of a management component. An example of the graphical user interface is a an SDDC manager user interface, which provides a single point of control for managing and monitoring Vmware® cloud foundation (VCF) instance and for provisioning workload domains. The request may include a resource type of the data center resource, a fully qualified domain name (FQDN) of the data center resource, and the time period for accessing a data center resource. In an example, the data center resource may include an on-premises resource of an on-premises computing system or a cloud resource of a cloud computing system. For example, the data center resource may include a server resource, a storage resource, a network resource, or a virtual resource in the data center such as server virtualization application 114, storage virtualization application 116, network virtualization and security application 118, or the like.

In response to receiving the request, data center manager 134 may create the temporary break glass account. In an example, data center manager 134 may create a new, temporary, one-time-use break glass account with a required privileged access to the data center resource, audit all elevated activity, and terminate the break glass account within a pre-defined amount of time or on log out. In an example, data center manager 134 may send a notification, seeking approval to create the temporary break glass account, to an administrator account (e.g., administrator device 126). In response to receiving the approval from the administrator account, data center manager 134 may create the temporary break glass account to access the data center resource for a specific duration. Further, data center manager 134 may notify credentials associated with the temporary break glass account to the user. Furthermore, data center manager 134 may enable an operation on the data center resource via the temporary break glass account using the credentials. For example, enabling the operation on the data center resource may include adding, deleting, or modifying a host computing system in data center 102.

Further during operation, scheduler 136 may delete the temporary break glass account in response to an expiration of a timer. For example, the timer may be configured based on the time period. In this example, scheduler 136 may initiate the timer based on the time period upon creating the temporary break glass account.

Further, data center manager 134 may generate an audit record of the temporary break glass account. The audit record may include information associated with the temporary break glass account such as user information, the data center resource information, and the like associated with the request. Further, data center manager 134 may store the audit record in a storage device associated with the management component for auditing the temporary break glass account.

Thus, examples described herein may significantly enhance the data center stack security by ensuring the privileged administrator accounts are used only when there is a true break glass scenario. Further, the fixed expiry time for break glass accounts may reduce operational overhead for the customers and ensures compliance to password rotation policies. Furthermore, the temporary break glass accounts can also ensure effective usage of the authorisation and prevent misuse of superuser break glass accounts. Also, the examples described herein may provide implicit audit of the user operations.

In some examples, the functionalities described in FIG. 1, in relation to instructions to implement functions of data center manager 134, scheduler 136, and any additional instructions described herein in relation to the storage medium, may be implemented as engines or modules including any combination of hardware and programming to implement the functionalities of the modules or engines described herein. The functions of data center manager 134 and scheduler 136 may also be implemented by a processor. In examples described herein, the processor may include, for example, one processor or multiple processors included in a single device or distributed across multiple devices.

Further, computing environment 100 illustrated in FIG. 1 is shown purely for purposes of illustration and is not intended to be in any way inclusive or limiting to the embodiments that are described herein. For example, a typical computing environment would include many more remote servers (e.g., physical host computing systems), which may be distributed over multiple data centers, which might include many other types of devices, such as switches, power supplies, cooling systems, environmental controls, and the like, which are not illustrated herein. It will be apparent to one of ordinary skill in the art that the example shown in FIG. 1, as well as all other figures in this disclosure have been simplified for ease of understanding and are not intended to be exhaustive or limiting to the scope of the idea.

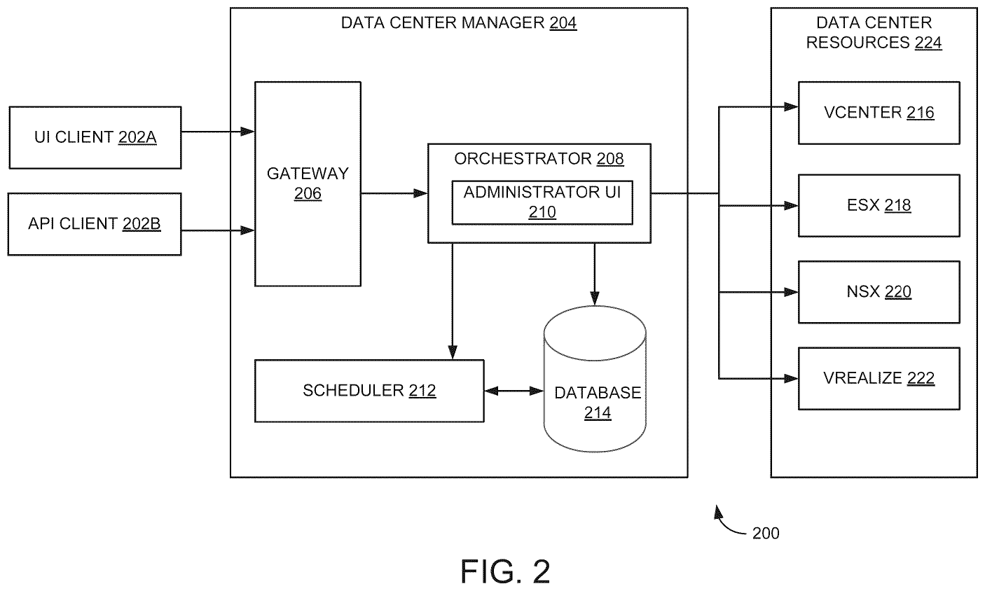

FIG. 2 is a block diagram of another example computing environment 200, depicting a data center manager 204 to generate a temporary break glass account for data center operations. As shown in FIG. 2, data center manager 204 (e.g., a software defined data center (SDDC) manager) may include a gateway 206 to communicate with an on-premises environment (e.g., a client device), an orchestrator 208 to create the temporary break glass account, a scheduler 212 to maintain the temporary break glass account, and a database 214 to store the temporary break glass account. Further, data center manager 204 may be communicatively connected to multiple data center resources 224 such as VMware® vCenter™ Server 216 (i.e., a centralized management utility to manage virtual machines), ESX server 218 (i.e., a virtualization tool to manage virtual machines), NSX 220 (e.g., a unified networking platform to build cloud-native application environments), and VMware vRealize Automation® 222 (i.e., a cloud management platform).

During operation, data center manager 204 may receive a request to create a temporary break glass account to perform data center operations on a data center resource. For example, the request may be received from different clients such as a user interface (UI) client 202A, an application programming interface (API) client 202B, or the like via gateway 206. Further, the request may include a time period for accessing the data center resource.

Upon receiving the request, orchestrator 208 may seek approval from an administrator to create the temporary break glass account via administrator UI 210. Further, when the approval from the administrator is received, orchestrator 208 may create and store the temporary break glass account in database 214 for a specific duration. Further, scheduler 212 may delete the temporary break glass account from database 214 in response to an expiration of a timer. For example, the timer may be configured based on the time period.

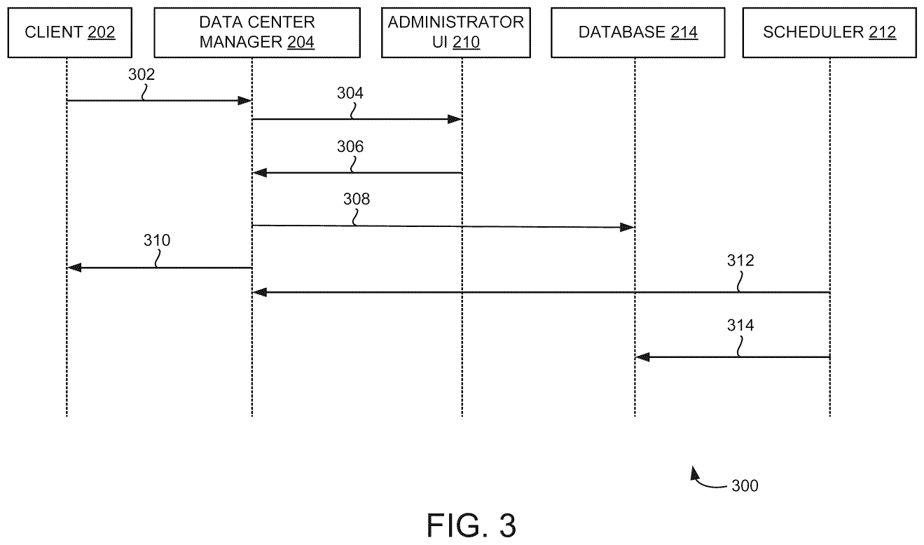

FIG. 3 is a sequence diagram 300 illustrating an example sequence of events to create a temporary break glass account corresponding to a user account. Sequence diagram 300 may represent the interactions and the operations involved in creating the temporary break glass account for data center operations. Similarly named elements of FIG. 3 may be similar in function and/or structure to elements described in FIG. 2. FIG. 3 illustrates process objects including client 202, data center manager 204, administrator UI 210, database 214, and scheduler 212. The vertical lines of client 202, data center manager 204, administrator UI 210, database 214, and scheduler 212 may represent the processes that may exist simultaneously. The horizontal arrows (e.g., 302, 304, 306, 308, 310, 312, and 314) may represent the data flow steps between the vertical lines originating from their respective process objects (e.g., client 202, data center manager 204, administrator UI 210, database 214, and scheduler 212).

At 302, data center manager 204 may receive a request to create a temporary break glass account from client 202. Upon receiving the request, data center manager 204 may send a notification to administrator UI 210 seeking approval to create the temporary break glass account, at 304.

At 306, data center manager 204 may receive the approval from administrator UI 210. Upon receiving the approval, data center manager 204 may create the temporary break glass account and details of the temporary break glass account may be stored in database 214, at 308. At 310, data center manager 204 may communicate credentials to access the temporary break glass account to client 202.

At 312, scheduler 212 may check a validity period of the temporary break glass account via data center manager 204. Upon expiry of the validity period, scheduler 212 may delete the temporary break glass account from database 214, at 314. Thus, examples described herein may apply a temporary break glass capability for the entire data center (e.g., SDDC) software stack from a single console.

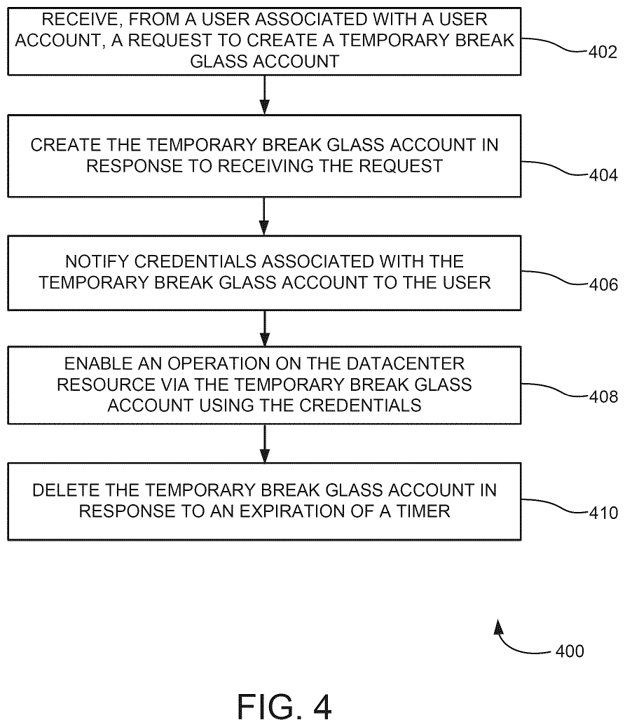

FIG. 4 is a flow diagram illustrating an example method 400 for creating a temporary break glass account to perform an operation on a data center resource. Example method 400 depicted in FIG. 4 represents generalized illustrations, and other processes may be added, or existing processes may be removed, modified, or rearranged without departing from the scope and spirit of the present application. In addition, method 400 may represent instructions stored on a computer-readable storage medium that, when executed, may cause a processor to respond, to perform actions, to change states, and/or to make decisions. Alternatively, method 400 may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but the flow chart illustrates functional information to design/fabricate circuits, generate computer-readable instructions, or use a combination of hardware and computer-readable instructions to perform the illustrated processes.

At 402, a request to create a temporary break glass account may be received from a user associated with a user account. For example, the request to create the temporary break glass account may be received via a graphical user interface of a management component. In an example, the request may include a time period for accessing a data center resource. Further, the request may include identification information associated with the data center resource. In an example, the data center resource may include an on-premises resource of an on-premises computing system or a cloud resource of a cloud computing system. For example, the data center resource may include a server resource, a storage resource, a network resource, or a virtual resource in the data center. In an example, the temporary break glass account may provide secure management control of the data center resource.

In response to receiving the request, at 404, temporary break glass account may be created. In an example, creating the temporary break glass account may include sending a notification, seeking approval to create the temporary break glass account, to an administrator account. Further, the temporary break glass account may be created in response to receiving the approval from the administrator account.

At 406, credentials associated with the temporary break glass account may be notified to the user. In an example, the credentials associated with the temporary break glass may be stored in a storage device associated with a management component. At 408, an operation may be enabled on the data center resource via the temporary break glass account using the credentials. At 410, the temporary break glass account may be deleted in response to an expiration of a timer. In an example, the timer may be configured based on the time period.

Further, method 400 may include generating an audit record of the temporary break glass account. In an example, the audit record may include information associated with the user and the data center resource. Furthermore, the audit record may be stored in a storage device associated with a management component for auditing the temporary break glass account. The audit record may facilitate in determining which user requested to create the temporary break glass account and on which data center resource the temporary break glass account is created.

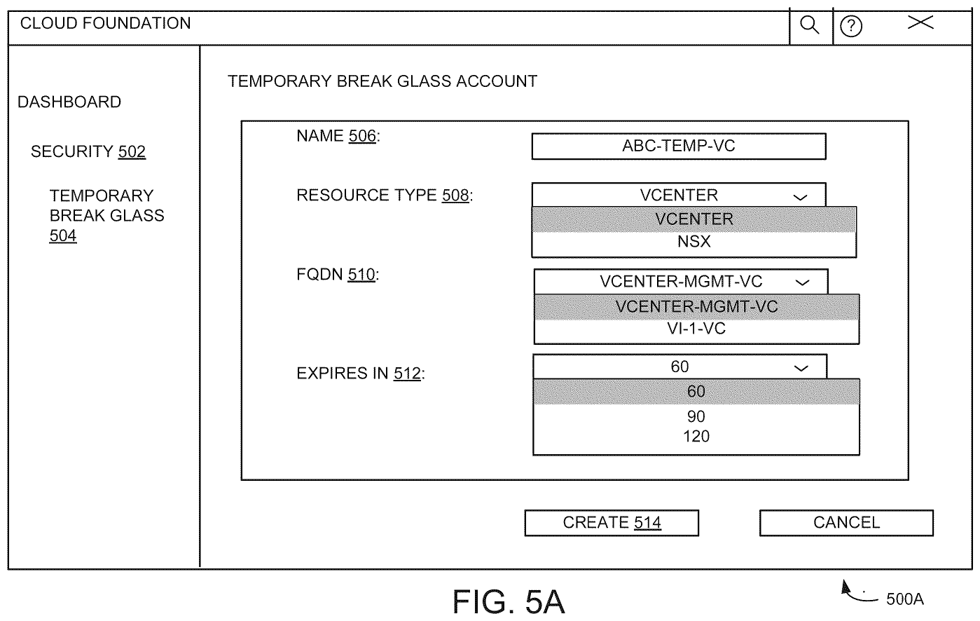

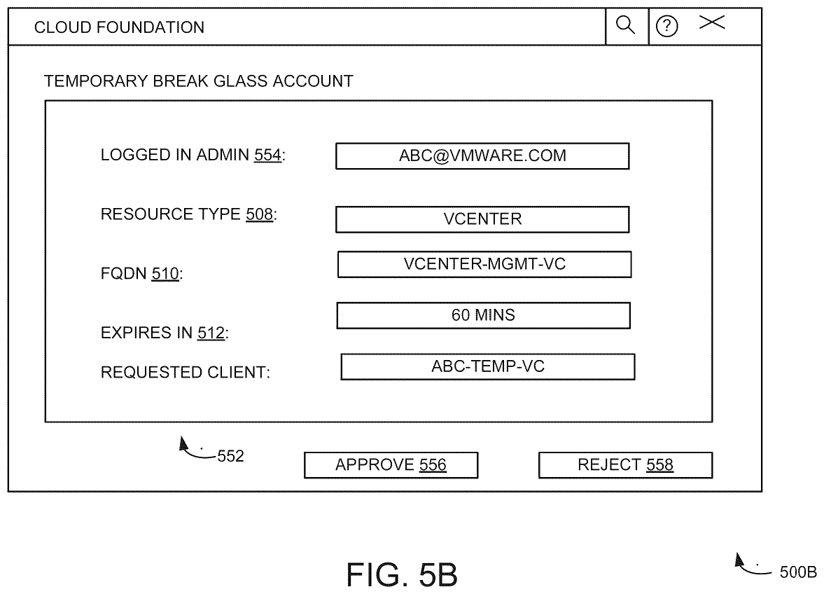

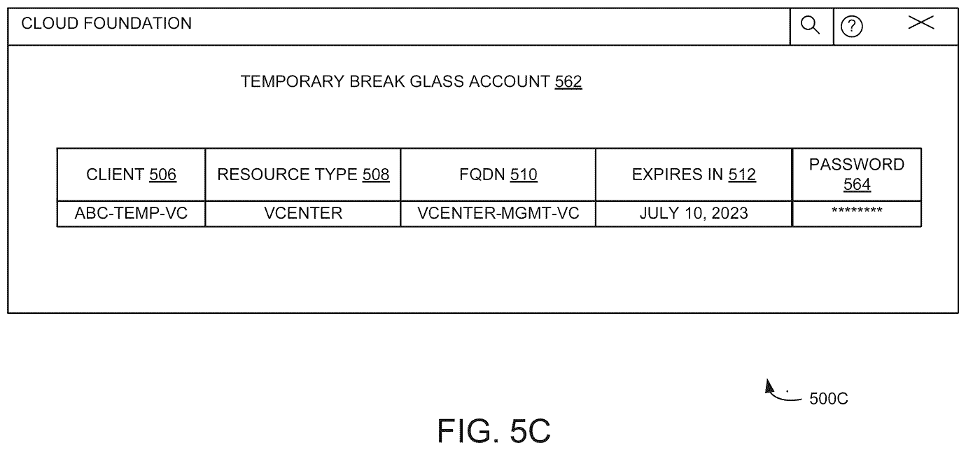

FIG. 5A is an example graphical user interface 500A of a user account, depicting user-selectable options to be included in a request to create a temporary break glass account. Example graphical user interface 500A may include an option “temporary break glass” 504 under “security” 502 to create the temporary break glass account. Upon selecting “temporary break glass” 504 option, graphical user interface 500A may display a menu of options to be included in the request to create the temporary break glass account. The menu of options may be displayed using a drop-down list, a menu ribbon, and so on. The menu of options may include “name” 506 for the temporary break glass account, “resource type” 508 of the data center resource on which the temporary break glass account needs to be created, a fully qualified domain name (“FQDN”) 510 of the data center resource, and “expires in” 512 (i.e., time period for accessing the data center resource). Upon providing inputs using the menu of options, the user can submit the request to create the temporary break glass account using an option “create” 514 on graphical user interface 500A.

FIG. 5B is an example graphical user interface 500B of an administrator account, depicting a notification 552 seeking the administrator's approval to create the temporary break glass account. Example notification 552 may display details of administrator (e.g., logged in admin 554) and details of the temporary break glass account. Further, graphical user interface 500B may include options for the administrator to “approve” 556 or “reject” 558 the request to create the temporary break glass account.

FIG. 5C is an example graphical user interface 500C of the user account, depicting details of created temporary break glass account 562. For example, the details of created temporary break glass account 562 may include “name” 506, “resource type” 508, “FQDN” 510, and “expires in” 512 as specified in FIG. 5A. Further, the details may include “password” 564 (i.e., credentials) to access the temporary break glass account 562. In an example, the details of temporary break glass account 562 may be stored in a database corresponding to a data center manager and can be viewed, by the user, via the graphical user interface 500C of the management component.

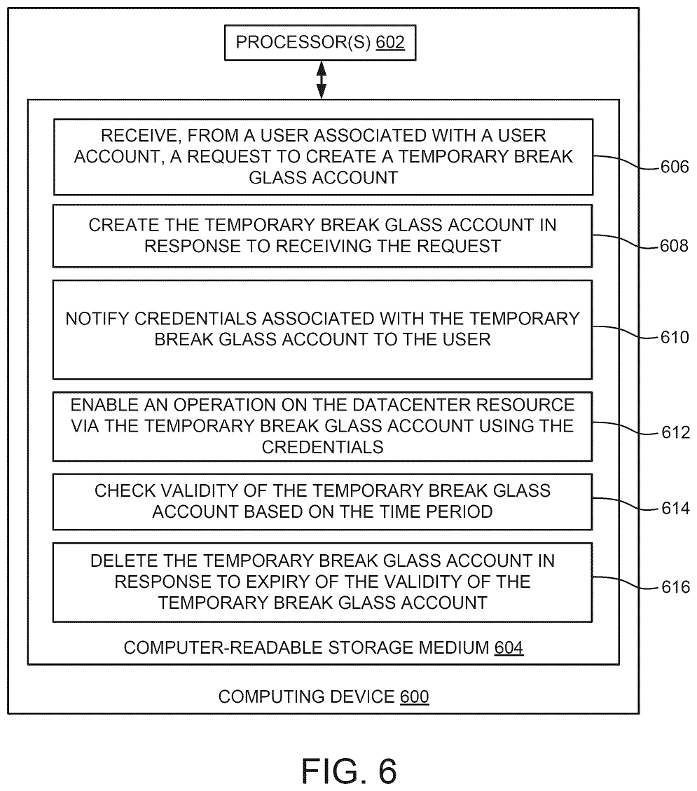

FIG. 6 is a block diagram of an example computing device 600 including non-transitory computer-readable storage medium 604 storing instructions to create a temporary break glass account associated with a user account to perform an operation on a data center resource. Computing device 600 may include a processor 602 and computer-readable storage medium 604 communicatively coupled through a system bus. Processor 602 may be any type of central processing unit (CPU), microprocessor, or processing logic that interprets and executes computer-readable instructions stored in computer-readable storage medium 604. Computer-readable storage medium 604 may be a random-access memory (RAM) or another type of dynamic storage device that may store information and computer-readable instructions that may be executed by processor 602. For example, computer-readable storage medium 604 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 604 may be a non-transitory computer-readable medium. In an example, computer-readable storage medium 604 may be remote but accessible to computing device 600.

Computer-readable storage medium 604 may store instructions 606, 608, 610, 612, 614, and 616. Instructions 606 may be executed by processor 602 to receive, from a user associated with a user account, a request to create a temporary break glass account. In an example, the request may include a time period for accessing a data center resource. For example, instructions 606 to receive the request may include instructions to receive the request to create the temporary break glass account via a graphical user interface of a management component. The request may include a resource type of the data center resource, a fully qualified domain name (FQDN) of the data center resource, and the time period for accessing a data center resource.

In response to receiving the request, instructions 608 may be executed by processor 602 to create the temporary break glass account. In an example, instructions 608 may include instructions to send a notification, seeking approval to create the temporary break glass account, to an administrator account. Further, the temporary break glass account may be created in response to receiving the approval from the administrator account.

Instructions 610 may be executed by processor 602 to notify credentials associated with the temporary break glass account to the user. Instructions 612 may be executed by processor 602 to enable an operation on the data center resource via the temporary break glass account using the credentials. Instructions 614 may be executed by processor 602 to check validity of the temporary break glass account based on the time period. Instructions 616 may be executed by processor 602 to delete the temporary break glass account in response to expiry of the validity of the temporary break glass account.

Further, computer-readable storage medium 604 may store instructions to generate an audit record of the temporary break glass account. In an example, the audit record may include information associated with the user and the data center resource. Furthermore, computer-readable storage medium 604 may store instructions to store the audit record in a storage device associated with a management component for auditing the temporary break glass account.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A computer-implemented method comprising:
receiving, from a user associated with a user account, a request to create a temporary break glass account, the request including a time period for accessing a data center resource;
in response to receiving the request, creating the temporary break glass account;
notifying credentials associated with the temporary break glass account to the user;
enabling an operation on the data center resource via the temporary break glass account using the credentials; and
deleting the temporary break glass account in response to an expiration of a timer, wherein the timer is configured based on the time period.

2. The method of claim 1, further comprising:
generating an audit record of the temporary break glass account, the audit record includes information associated with the user and the data center resource; and
storing the audit record in a storage device associated with a management component for auditing the temporary break glass account.

3. The method of claim 1, further comprising:
storing the credentials associated with the temporary break glass in a storage device associated with a management component.

4. The method of claim 1, wherein the data center resource comprises an on-premises resource of an on-premises computing system or a cloud resource of a cloud computing system.

5. The method of claim 1, wherein creating the temporary break glass account comprises:
sending a notification, seeking approval to create the temporary break glass account, to an administrator account; and
creating the temporary break glass account in response to receiving the approval from the administrator account.

6. The method of claim 1, wherein receiving the request to create the temporary break glass account comprises:
receiving the request to create the temporary break glass account via a graphical user interface of a management component.

7. The method of claim 1, wherein the temporary break glass account is to provide secure management control of the data center resource.

8. The method of claim 1, wherein receiving the request comprises:
receiving, via a graphical user interface of a management component, the request comprising identification information associated with the data center resource.

9. The method of claim 1, wherein the data center resource comprises a server resource, a storage resource, a network resource, or a virtual resource in the data center.

10. A management node comprising:
a processor; and
a memory comprising:
a data center manager to:
receive, from a user associated with a user account, a request to create a temporary break glass account, the request including a time period for accessing a data center resource;
in response to receiving the request, create the temporary break glass account;
notify credentials associated with the temporary break glass account to the user; and
enable an operation on the data center resource via the temporary break glass account using the credentials; and
a scheduler to delete the temporary break glass account in response to an expiration of a timer, wherein the timer is configured based on the time period.

11. The management node of claim 10, wherein the data center manager is to:
generate an audit record of the temporary break glass account, the audit record includes information associated with the user and the data center resource; and
store the audit record in a storage device associated with a management component for auditing the temporary break glass account.

12. The management node of claim 10, wherein the data center resource comprises an on-premises resource of an on-premises computing system or a cloud resource of a cloud computing system.

13. The management node of claim 10, wherein the data center manager is to:
send a notification, seeking approval to create the temporary break glass account, to an administrator account; and
create the temporary break glass account in response to receiving the approval from the administrator account.

14. The management node of claim 10, wherein the data center manager is to:
receive the request to create the temporary break glass account via a graphical user interface of a management component, the request comprising a resource type of the data center resource, a fully qualified domain name (FQDN) of the data center resource, and the time period for accessing a data center resource.

15. The management node of claim 10, wherein the data center resource comprises a server resource, a storage resource, a network resource, or a virtual resource in the data center.

16. The management node of claim 10, wherein the scheduler is to:
upon creating the temporary break glass account, initiate the timer based on the time period, wherein the time period is to indicate an amount of permitted time or permitted period to perform the operation on the data center resource.

17. A non-transitory machine-readable storage medium encoded with instructions that, when executed by a processor of a computing device, cause the processor to:
receive, from a user associated with a user account, a request to create a temporary break glass account, the request including a time period for accessing a data center resource;
in response to receiving the request, create the temporary break glass account;
notify credentials associated with the temporary break glass account to the user;
enable an operation on the data center resource via the temporary break glass account using the credentials;
check validity of the temporary break glass account based on the time period; and
delete the temporary break glass account in response to expiry of the validity of the temporary break glass account.

18. The non-transitory machine-readable storage medium of claim 17, further comprising instructions to:
generate an audit record of the temporary break glass account, the audit record includes information associated with the user and the data center resource; and
store the audit record in a storage device associated with a management component for auditing the temporary break glass account.

19. The non-transitory machine-readable storage medium of claim 17, further comprising instructions to:
send a notification, seeking approval to create the temporary break glass account, to an administrator account; and
create the temporary break glass account in response to receiving the approval from the administrator account.

20. The non-transitory machine-readable storage medium of claim 17, wherein instructions to receive the request comprise instructions to:
receive the request to create the temporary break glass account via a graphical user interface of a management component, the request comprising a resource type of the data center resource, a fully qualified domain name (FQDN) of the data center resource, and the time period for accessing a data center resource.
